(19) United States
(12) Patent Application Publication
(10) Pub. No.: US 2012/0240672 A1
(43) Pub. Date: Sep. 27, 2012

(54) MINIATURIZED ENERGY GENERATION SYSTEM

(76) Inventors: Alexander Frey, Munchen (DE); Ingo Kühne, Munchen (DE)

(21) Appl. No.: 13/514,442

(22) PCT Filed: Nov. 29, 2010
(86) PCT No.: PCT/EP10/68379

§ 371 Date: Jun. 7, 2012

(51) Int. Cl. B60C 23/04; H02N 2/18

(52) U.S. Cl. 73/146.5; 310/314

(57) ABSTRACT

An autonomous energy generation system, in particular designed as an integrated miniaturized energy generation system based on MEMS technology, has a piezoelectric energy converter for converting mechanical energy into electrical energy, and has at least one piezoelectric element into which mechanical force (in particular deformation force) induced by a fluid flow can be coupled. The piezoelectric element is excited to vibrate mechanically. An integrated circuit (ASIC) is used for managing the energy provided by the piezoelectric energy converter.

### CROSS REFERENCE TO RELATED APPLICATIONS

This application is based on and hereby claims priority to International Application No. PCT/EP2010/068379 filed on Nov. 29, 2010 and German Application Nos. 10 2009 057 279.1 filed on Dec. 7, 2009 and 10 2010 019 740.8 filed on May 7, 2010, the contents of which are hereby incorporated by reference.

### BACKGROUND

The invention relates to an energy-generation system. The invention relates further to a method for providing energy for an energy-self-sufficient system.

Increasing use is being made of actuators and sensors based on MEMS (Micro Electro-Mechanical Systems) technology. Of particular interest therein are actuator or, as the case may be, sensor nodes and networks that operate energy-self-sufficiently. Systems of such kind obtain the electric energy needed for operating individual components not from an ac power-supply system or a battery but from their surroundings via a suitable energy converter.

A major field is therein to be found in the automotive industry in connection with, for instance, tire-pressure monitoring systems (tire sensor systems). Present-day tire-pressure monitoring systems monitor pressure variations in a car tire by measuring the pressure and temperature at specific intervals and sending the results wirelessly to a control unit. Electric components required therefor are secured to a rim of the car tire via a valve. The energy needed for operating the tire-pressure monitoring system is supplied from a battery. The battery limits the tire-pressure monitoring system's service life.

Also known are systems that are fed via a solar cell. The use of such systems is, though, limited in the area of industrial automation given the significantly reduced light budget often associated therewith.

### SUMMARY

One possible object is to provide a miniaturized energy-generation system that will make autonomous energy provisioning and controlling possible for decentralized systems particularly in the industrial sector.

The inventors propose an energy-generation system embodied in particular as an integrated miniaturized energy-generation system, comprising:

a) a piezoelectric energy converter for converting mechanical energy into electric energy, having at least one piezoelectric element into which a mechanical force induced by a fluid flow can be coupled in such a way that the piezoelectric element will be excited to mechanically vibrate;

b) a housing having a housing chamber in which the piezoelectric element is located and through which the fluid flow can be ducted;

c) means for changing the volume of the housing, with mechanical deformation energy being converted into fluidic pressure energy by the change in volume; and

d) an integrated circuit (ASIC) for managing the energy provided by the piezoelectric energy converter. The kind of conversion of mechanical energy into electric energy that has been described can be employed wherever a fluid flow can be generated, for example in a motor vehicle's tire. The fluid flow is therein ducted past a suitably embodied piezoelectric element in such a way that the element will be excited to produce mechanical vibrations. The mechanical vibrations are used to obtain electric energy. The energy obtained is conditioned by the power-management system (ASIC: Application-Specific Integrated Circuit, for power management) and made available to a load (decentralized actuators or sensors, for example). That will enable the decentralized systems to operate autonomously, which is to say without cables or batteries. The systems can hence be operated in a basically maintenance-free manner.

The fluid is preferably a gas or gas mixture. A fluid in the form of a liquid is also conceivable. The liquid is therein preferably electrically insulating.

The housing in which the piezoelectric element is located and through which the fluid flow can be ducted advantageously has a fluid-flow inlet and a fluid-flow outlet. The fluid flows into or, as the case may be, out of the housing chamber through respectively the fluid-flow inlet or outlet. The fluid is therein ducted past the piezoelectric element and causes it to vibrate.

A first advantageous embodiment is that a pressure surge or pressure suction can be generated in the fluid flow by the means for changing the volume of the housing. That enables the energy-generation system to be employed in environments that can be dynamically deformed in any way, for example in conveyor belts, at whose turning points the elastic conveyor belt is deformed, or in the field of industrial automation (robots, for instance), where there are very many moving parts that are protected by, for example, deformable rubber cuffs.

In another advantageous embodiment the means for changing the volume of the housing are formed by an elastically deformable wall of the housing or of a part of the housing. A pressure surge or pressure suction is generated in the fluid flow by the means for changing the volume of the housing. The piezo element is excited to vibrate mechanically by the pressure surge or, as the case may be, pressure suction. The piezo element, for example the piezo strip, will experience a decaying oscillation when excited by a fluid surge. A periodic charge separation between the electrodes is produced via the piezoelectric effect. The charge flow that can be obtained therefrom will then be externally available as electric energy. To ensure that the force of the pressure surge or, as the case may be, pressure suction can be efficiently coupled into the piezo element, the piezo element is curved, for example, or there are suitable flow-impact geometries on its surface or the flow impacts directly perpendicularly.

The elastically deformable wall is for example a wall of a cavity in a car tire's casing. The elastically deformable wall is linked to the car tire in such a way that a defined deformation of the tire's tread-contact area will result in defined deforming of the cavity's wall and hence in defined deforming of the cavity. A defined pressure surge will develop owing to the defined deformation of the cavity. The tire itself will consequently be able to provide the energy necessary for operating the tire sensors. The deformations described are moreover independent of the vehicle's speed. Only a frequency of pressure-surge formation is dependent on the vehicle's speed.

Also conceivable as an elastically deformable wall of the housing is a membrane forming a constituent part of the housing wall. The elastically deformable wall is a rubber membrane, for example.

In another advantageous embodiment the means for changing the volume of the housing are formed by deformable mechanical parts of the housing or of a part of the housing. Those can be, for example, mechanical joints or hinges that are mounted in the housing and which when actuated will cause the volume in the housing to be reduced or increased. The pressure or suction produced by the change in volume is coupled into the piezo element and transformed into vibrations. Mechanical deformation energy is converted thereby into fluidic pressure energy. The housing or parts of the housing can also be embodied in the form of bellows to produce pressure or suction though changes in volume.

In another advantageous embodiment the piezoelectric element has a multilayer structure comprising MEMS layers (meaning that Micro Electro-Mechanical Systems technology is employed). The piezoelectric element has a layer sequence formed of an electrode layer, a piezoelectric layer, and another electrode layer. A plurality of layer sequences of such kind can therein be stacked one upon the other to produce a multilayer structure comprising alternating electrode and piezoelectric layers stacked one upon the other. When the piezo element is being fabricated with the aid of MEMS technology it is possible by appropriate lateral tensile or, as the case may be, compressive stress in and between the individual layers to produce the layer stack in such a way that it will curve or, as the case may be, furl slightly when layers are exposed.

The electrode material of the electrode layers can therein include all kinds of metals or, as the case may be, metal alloys. Platinum, titanium, and a platinum/titanium alloy are examples of the electrode material. Non-metallic, electrically conducting materials are also conceivable.

The piezoelectric layer can likewise be formed of all kinds of materials. Examples are piezoelectric ceramic materials such as lead zirconate titanate (PZT), zinc oxide (ZnO), and aluminum nitride (AIN). Piezoelectric organic materials such as polyvinyldifluoride (PVDF) or polytetrafluorethylene (PTFE) are likewise conceivable.

In another advantageous embodiment the piezoelectric element has a piezo strip. The piezoelectric element is therein embodied as a flexure element, preferably as a piezo strip. The flexure element is for that purpose a piezoelectric bending actuator, for instance. For example ceramic green films printed with a metallic coating for the electrode layers are stacked one upon the other and sintered to produce the bending actuator. The result is a monolithic bending actuator. The bending actuator can therein be embodied in any way, for example as a bimorph actuator.

MEMS technology is especially suitable for realizing the bending actuator in view of the targeted miniaturization. A piezoelectric energy converter having very small lateral dimensions is accessible with that technology. Very thin layers can moreover be embodied. Thus the electrode layers are for example 0.1 μm to 0.5 μm thick. The piezoelectric layer is a few μm thick, for example 1 μm to 10 μm. The piezoelectric element is embodied as a thin piezoelectric membrane or, as the case may be, cantilever beam. The piezoelectric element has a very small mass. A piezoelectric element of such kind can furthermore be easily excited to mechanically vibrate. A support layer, for example one made of silicon, polysilicon, silicon dioxide (SiO₂), or silicon nitride (Si₃N₄), can be provided to complete the piezo element in the form of a piezoelectric membrane or, as the case may be, cantilever beam. The support layer's thickness is selected from a range of 1 μm to 100 μm. The support layer is optional.

In another advantageous embodiment the piezo strip has a substantially triangular base area. That will provide highly efficient energy converting.

In another advantageous embodiment the piezoelectric element is embodied as a membrane and the fluid flow impacts substantially perpendicularly on the membrane, with the membrane having at least two intersecting membrane slots.

The piezoelectric membrane has a layer sequence including an electrode layer, a piezoelectric layer, and another electrode layer. A plurality of layer sequences of such kind can therein be stacked one upon the other to produce a multilayer structure comprising alternating electrode and piezoelectric layers stacked one upon the other. The membrane can have a substantially circular base area, although rectangular membranes are also conceivable.

A displacement (deformation) of the piezoelectric layer due to the impact on the piezoelectric layer of a mechanical force results in charge shifting or, as the case may be, separating in the piezoelectric layer (piezoelectric effect). The two electrode layers and the piezoelectric layer are therein arranged next to each other in such a way that a charge flow resulting from charge separating can be used to obtain electric energy. The result is the conversion of mechanical energy into electric energy.

The electrode material of the electrode layers includes all kinds of metals or, as the case may be, metal alloys. Platinum, titanium, and a platinum/titanium alloy are examples of the electrode material. Non-metallic, electrically conducting materials are also conceivable.

The piezoelectric layer can likewise be formed of all kinds of materials. Examples are piezoelectric ceramic materials such as lead zirconate titanate (PZT), zinc oxide (ZnO), and aluminum nitride (AIN). Piezoelectric organic materials such as polyvinyldifluoride (PVDF) or polytetrafluorethylene (PTFE) are likewise conceivable.

The energy converter can have lateral dimensions ranging from a few mm to a few cm. The same applies to the membrane's lateral dimensions. The layers of the membrane range from a few μm to a few mm in thickness.

The piezoelectric membrane is positioned in the energy converter in such a way that the fluid flow impacts substantially perpendicularly on the membrane and causes it to vibrate. The membrane slots advantageously intersect substantially in the center of the membrane and form triangles in the membrane structure. The force impact of the fluid flow is used in that way through the triangular arrangement for efficient energy converting.

The membrane slots reduce the membrane's rigidity. The membrane has a lateral diameter (diameter of a membrane-slot opening) of a few μm. The membrane's diameter is selected from a range of, for example, up to a few mm.

In another advantageous embodiment the piezoelectric energy converter has piezoelectric elements that have a substantially triangular base area and are arranged in such a way that the result is a substantially square overall base area, with the fluid flow impacting substantially perpendicularly on the overall base area. The piezoelectric elements are therein linked along their respective side edges to the inside of the energy converter or, as the case may be, to a fluid flow guide belonging to the energy converter. That arrangement will ensure efficient energy converting.

In another advantageous embodiment a plurality of piezoelectric energy converters are connected one behind the other. The amount of energy generated will be increased thereby. Systems requiring larger amounts of energy can hence also be supplied. It will thereby furthermore be possible to scale the energy-generation system in terms of the energy required.

In another advantageous embodiment the integrated circuit (ASIC) is used for power managing an energy-self-sufficient sensor and/or actuator system. The integrated circuit (ASIC) for managing the energy provided by the piezoelectric energy converter enables energy to be supplied to an extent matching the respective energy requirements of the decentralized system requiring to be supplied. The energy available for the load can be accommodated and maximized thereby.

By coupling a force induced by the fluid flow into the piezoelectric element, the piezoelectric element will be excited to mechanically vibrate and with the amount of energy for a system being fed by the integrated circuit (ASIC) keeping with what is needed. The energy made available in keeping with what is needed will allow energy consumption to be optimized by being in each case matched to the respective requirements. That will enhance the performance and reliability of the decentralized systems requiring to be supplied with energy (actuators/sensors, for example).

In another advantageous embodiment a stationary fluid flow is used. It is possible for a stationary (time-invariant) fluid flow to be used for producing the piezoelectric element's mechanical vibrations. For example a fluid-flow obstacle will have been positioned in the housing chamber for that purpose. Ducting the fluid flow past the fluid-flow obstacle gives rise to turbulences that will excite a freely moving piezo element to vibrate.

In another advantageous embodiment a fluid flow that changes over time is used. The fluid flow changing over time will therein be triggered not only by a pressure surge or pressure suction but also by permanent pressure variations such as customarily occur in car tires while they are rolling.

Summarizing, the following particular advantages will emerge:

The energy-generation system can be employed at places that exist anyway (for example conveyor belts, rubber cuffs, tires) with no need for structural alterations and without affecting the existing surroundings (that is made possible particularly by the miniaturized design used in MEMS technology).

The energy-generation system makes it possible to provide an autonomous and specifically targeted (scaled) energy supply for decentralized systems (actuators/sensors, for example).

The integrated circuit (ASIC) for managing the energy provided by the piezoelectric energy converter enables energy to be supplied to an extent matching the respective energy requirements of the decentralized system requiring to be supplied (for example in standby mode: low energy consumption; in load mode: high energy consumption). It is also possible to provide the ASIC with an energy-storage means (a capacitor, for instance). Power managing can be further optimized thereby.

There is no need for a seismic mass as is employed in a vibration-based spring-mass system for converting mechanical energy into electric energy.

The piezoelectric energy converter can be operated resonantly, meaning at the resonance frequency of the piezoelectric cantilever beam/membrane. It does not have to be, though. Thus it can be operated on a broadband basis (in a frequency range of a few Hz to a few hundred kHz) while maintaining a high degree of efficiency (provided sufficient mechanical energy is available) in terms of converting the mechanical energy into electric energy.

Undesired speed-dependent centrifugal forces play no role in converting the mechanical energy into electric energy owing to the energy converter's negligible mass.

Exploiting the deformation in the tread-contact area (particularly when the system is implemented in the tire)—where what occurs is a pressure surge in the fluid flow—enables a pressure surge to be generated by a simple process that is integrated in the tire and so provides a simple solution for converting mechanical energy into electric energy.

It is possible to exploit static fluid flows (ones not changing over time) in the (car) tire for obtaining electric energy.

The efficiency with which mechanical energy can be converted into electric energy is independent of a rotational speed of the tire.

An encapsulated structure providing mechanical overload protection is possible with the aid of the housing.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a first example of a piezoelectric energy converter for use in the proposed energy-generation system in a lateral cross-section,

FIG. 2 shows a second example of a piezoelectric energy converter for use in the energy-generation system, likewise in a lateral cross-section,

FIG. 3 is a top view of a piezoelectric membrane for use in a piezoelectric energy converter,

FIG. 4a is a first exemplary schematic of the energy-generation system in the idle condition,

FIG. 4b is a second exemplary schematic of the energy-generation system having a reduced chamber volume,

FIG. 4c is a third exemplary schematic of the energy-generation system having an expanded chamber volume,

FIG. 5 shows a tire from the side with tread-contact area as an example of the energy-generation system's use,

FIG. 6 shows an exemplary piezoelectric strip (or, as the case may be, a piezoelectric cantilever beam) having a substantially triangular base area, and

FIG. 7 shows an exemplary arrangement of piezoelectric elements.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

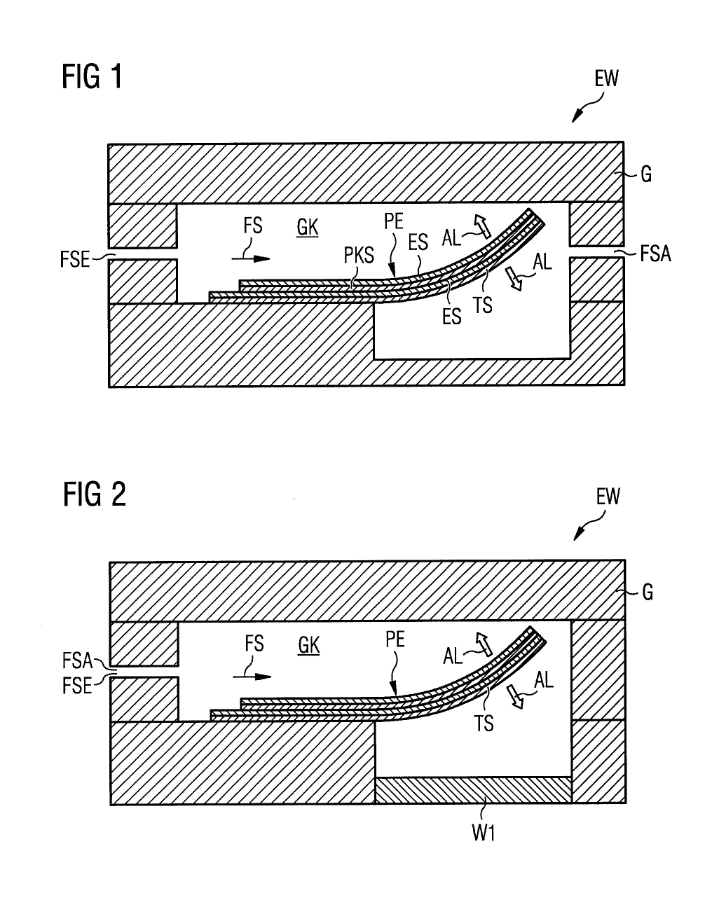

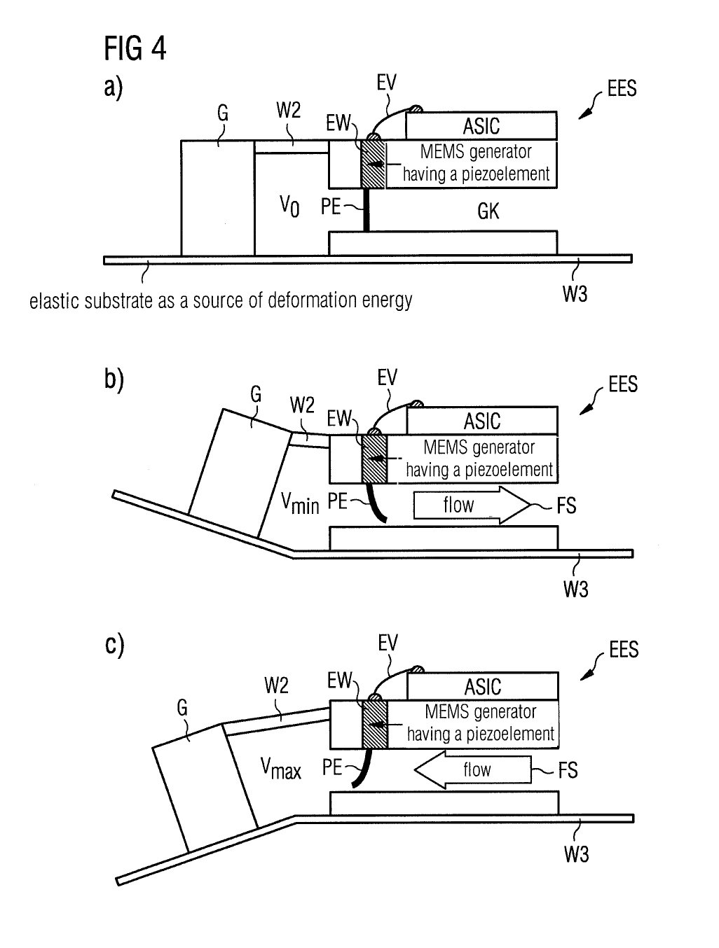

FIG. 1 shows a first example of a piezoelectric energy converter EW for use in the energy-generation system EES (FIGS. 4a-4c) in a lateral cross-section. Piezoelectric energy converter EW is used for converting mechanical energy into electric energy. Energy converter EW has a piezoelectric element PE. Piezoelectric element PE has a layer sequence formed of electrode layer ES, piezoelectric layer, and another electrode layer. Piezoelectric element PE is based on MEMS technology. The piezoelectric layer is a piezoceramic layer PKS made of lead zirconate titanate. The piezoceramic layer can alternatively be made of aluminum nitride or zinc oxide. Electrode layers ES are made of platinum. The termination is formed by an optional support layer TS made of silicon nitride. The support layer can alternatively be made of silicon dioxide.

Piezoelectric element PE is arranged in a housing chamber GK of a housing G. It is therein ensured that fluid flow FS is ducted past piezoelectric element PE. A mechanical force induced by fluid flow FS is therein coupled into piezo element PE. The result is a displacement AL of piezoelectric element PE with consequent charge separating on the basis of which electric energy can be obtained via the electrodes.

In the example shown in FIG. 1, a fluid-flow inlet FSE and a fluid-flow outlet FSA are integrated in housing G and located opposite each other. It will be clear to a person skilled in the relevant art that other arrangements or embodiments are also possible for fluid-flow inlet FSE and fluid-flow outlet FSA. Fluid-flow inlet FSE and fluid-flow outlet FSA can also be arranged on or, as the case may be, attached to the same side of housing G. It is furthermore also possible to use a single (common) opening in housing G for fluid-flow inlet FSE and fluid-flow outlet FSA.

In the example shown in FIG. 1, piezoelectric element PE is a bent piezo strip. The piezo strip is therein embodied such that ducting fluid flow FS past it and consequently coupling the mechanical force into it will excite the piezo strip to mechanically vibrate.

FIG. 2 shows a second example of a piezoelectric energy converter EW for use in energy-generation system EES (FIGS. 4a-4c), likewise in a lateral cross-section. In the example shown in FIG. 2, housing G has a device means W1 for changing the volume of the housing. In that embodiment a pressure surge or pressure suction is produced in fluid flow FS by the device W1 for changing the volume of the housing. The device is, for example, a cavity having an elastically deformable wall W1. Exerting a mechanical pressure on said elastically deformable wall W1 will produce a pressure surge or pressure suction depending on the direction from which the mechanical pressure is exerted on the device W1. The pressure surge or, as the case may be, pressure suction that is produced is transmitted to piezo strip PE. The above-described mechanical vibrating will ensue.

Elastically deformable wall W1 for producing the pressure surge or, as the case may be, pressure suction can be integrated in housing G. In an embodiment the wall is a rubber membrane. The example in FIG. 2 shows a housing having only one opening that can be used for fluid-flow inlet FSE and fluid-flow outlet FSA.

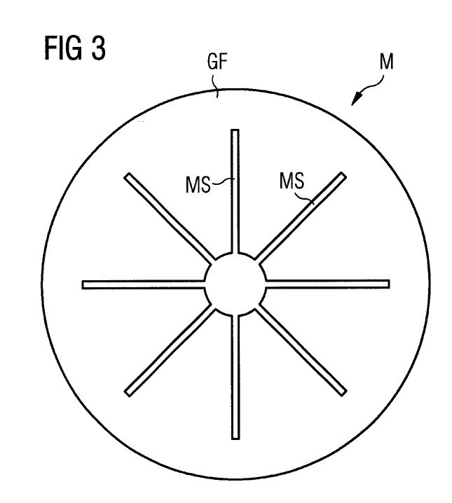

FIG. 3 is a top view of a piezoelectric membrane M for use in a piezoelectric energy converter EW, suitable for being employed in energy-generation system EES (FIGS. 4a-4c). As a piezoelectric element, in housing G it is also possible to use a membrane M that is arranged in such a way that fluid flow FS will impact on membrane M and excite it to vibrate. Electric energy and an electric voltage will be generated owing to displacement AL or, as the case may be, deforming of the piezoelectric layer of piezoelectric membrane M due to the pressure surge or, as the case may be, pressure suction in fluid flow FS. Base area GF of membrane M is advantageously circular or rectangular. A symmetric shape will make it easier to install the membrane in the energy converter.

To reduce the mechanical load on the membrane it is advantageous for housing G to be fitted with suitable counter bearings so that membrane M will not be mechanically overloaded. Counter bearings of such kind are, for example, an abutting surface integrated in the lower part of the housing or a corresponding abutting structure in a lid of the housing. The abutting surface or, as the case may be, abutting structure will ensure that membrane M cannot be deflected further. By limiting the degree of displacement AL they act as overload protectors for membrane M.

It is advantageous for membrane M to have membrane slots MS that pass through membrane M. Membrane slots MS are oriented and arranged radially toward the membrane's center. Membrane slots MS serve to lessen the rigidity of membrane M.

Piezoelectric membrane M is positioned in the energy converter in such a way that fluid flow FS will impact substantially perpendicularly upon it and cause it to vibrate. Membrane slots MS intersect advantageously substantially in the center of membrane M and form triangles in the membrane structure. The force impact of fluid flow FS is used in that way through the triangular arrangement for efficient energy converting.

FIGS. 4a to 4c show an exemplary embodiment of energy-generation system EES in different operating conditions.

Many novel applications require a sophisticated sensor and/or actuator system. Said systems are often locally distributed so that supplying electric energy is complicated and hence also expensive (because of laying electric supply leads, for instance). In some applications it is totally impossible to physically link in decentralized systems of such kind so they have to be operated fully autonomously. That means these sensors have to supply themselves with energy and the measurement data obtained will be transmitted without cables.

There are numerous dynamically deformable environs in our industrialized world that are suitable for energy harvesting particularly in decentralized environs. Conveyor belts at whose turning points the elastic belt is substantially deformed are an example. Those mechanical deformations provide a source of deformation energy that can be converted into electric energy and thus supply the decentralized sensor and/or actuator system with power. Robots that have very many moving parts and are usually protected by deformable rubber cuffs are furthermore employed in industrial automation. Said rubber cuffs are also a source of deformation energy. Another example is to be found in the area of automotive technology. A car tire's casing is continuously subjected to mechanical deformations while in use. Those deformations can be used for obtaining electric energy. The energy obtained from the deformation of car tires can be used for sensors that monitor, for example, the tire pressure or tire temperature. A system of such kind does not require any batteries for supplying energy and so will basically be maintenance-free. A simple approach to obtaining energy from mechanical deformations with the aid of the piezoelectric effect is, for example, to directly attach the piezo structure to the mechanical part undergoing deformation (a conveyor belt, for example, or the inside of a tire or a rubber cuff). Systems of such kind make an autonomous energy supply possible for actuators and/or sensors installed on a decentralized basis. Said systems are maintenance-free and will not require a change of battery, a factor impacting positively also from the environmental aspect.

FIGS. 4a to 4c show an exemplary embodiment of energy-generation system EES in different operating conditions. Energy-generation system EES includes a piezoelectric MEMS generator, an integrated circuit ASIC functioning as a power-management system, an electric connection EV between energy converter EW and integrated circuit ASIC, and a chamber GK that is integrated in the housing and has a changeable volume for converting mechanical deformation energy into fluidic pressure energy. The mechanical deformation is caused by changing the volume of the housing. For changing the volume, for example, an elastic substrate functions as a source of deformation on which the housing is mounted or a membrane mounted inside the housing as an integrated wall, with the membrane being advantageously embodied as a rubber membrane. A mechanical deformation results in a reduced or expanding chamber volume depending on the specific embodiment. That change in volume produces a fluidic flow FS having a pressure energy that is converted by the MEMS piezo generator into electric energy. Said primary electric energy is made available via electric connection EV of the integrated circuit (ASIC). Operating as a power-management system, the ASIC conditions said primary energy and makes it available to a load (a sensor or actuator, for instance). The ASIC is equipped with an intelligence function enabling the respective load to be supplied with energy in a specifically targeted, application-oriented, and scalable manner. The amount of energy produced can be increased by MEMS generators connected one behind the other. Energy scaling is therefore possible that will allow respectively accommodated or, as the case may be, necessary amounts of energy to be made available.

FIG. 4a shows a first exemplary schematic of energy-generation system EES in the idle condition. Energy-generation system EES includes a housing G having a housing chamber GK in which piezoelectric element PE is located and through which fluid flow FS can be ducted. It further includes an MEMS generator functioning as a piezoelectric energy converter for converting mechanical energy into electric energy, with piezoelectric element PE of energy converter EW being excited by a mechanical force induced by fluid flow FS to produce mechanical vibrations which are in turn converted into electric energy. The electric energy provided by energy converter EW is made available via an electric connection EV (for example a wire or cable connection) to the ASIC which functions as a power-management and is able to extend said energy to the respective loads. Energy-generation system EES further includes devices W2, W3 for changing the volume of the housing. For changing the volume of the housing, an elastic substrate (a conveyor belt or tire casing, for instance) can serve as a source of deformation and/or a membrane may be integrated in housing G or, as the case may be, in the housing wall.

FIG. 4b is a second exemplary schematic of energy-generation system EES in the operating condition having a reduced chamber volume. Energy-generation system EES is in the example shown in FIG. 4b attached to an elastic substrate as a source of deformation energy. A part of said elastic substrate constitutes a housing wall W3. The volume inside housing G will be reduced by a deformation of the elastic substrate in the region of wall W3. Positioned opposite the elastic substrate is another flexible wall W2 (a rubber membrane, for example) of housing G, which substrate can be mechanically pulled flexibly either together or apart depending on whether the chamber volume is reduced or expanding.

FIG. 4c is a third exemplary schematic of energy-generation system EES in an operating condition having an expanded chamber volume. In the example shown in FIG. 4c, the elastic substrate is moved in the region of flexible wall W3 in such a way as to produce an expanded chamber volume inside housing G. Wall W2 positioned substantially opposite wall W3 is in this example expanded owing to the deformation of W3. In the example shown in FIG. 4c, a fluid flow FS toward the housing's interior is produced owing to the expanded chamber volume. Piezo element PE is made to vibrate by fluid flow FS. The chamber volume's expansion causes a suction effect (pressure suction) that produces fluid flow FS. In the example shown in FIG. 4c, fluid flow FS therein penetrates substantially through an opening in the housing and causes piezo element PE to vibrate.

Fluid flow FS will be directed toward the housing's exterior when the chamber volume has been reduced as shown in FIG. 4b. The air (or another gas) will be pressed together in the housing chamber by the reduction in the chamber volume and a pressure surge (which can escape through an opening in the housing) will result that produces fluid flow FS. Piezo element PE will again be made to vibrate by fluid flow FS.

Energy-generation system EES can be realized in the basis of MEMS (Micro Electro-Mechanical Systems) technology and thereby makes miniaturizing possible that will allow the system to be very easily integrated at decentralized locations for supplying energy. Advantages of the proposals are to be found particularly in the exploitation of mechanical deformation energy present in any event, decoupling of the primary forces of the sensitive piezo ceramic (implicit overload protection) in a compact design, and the low mass.

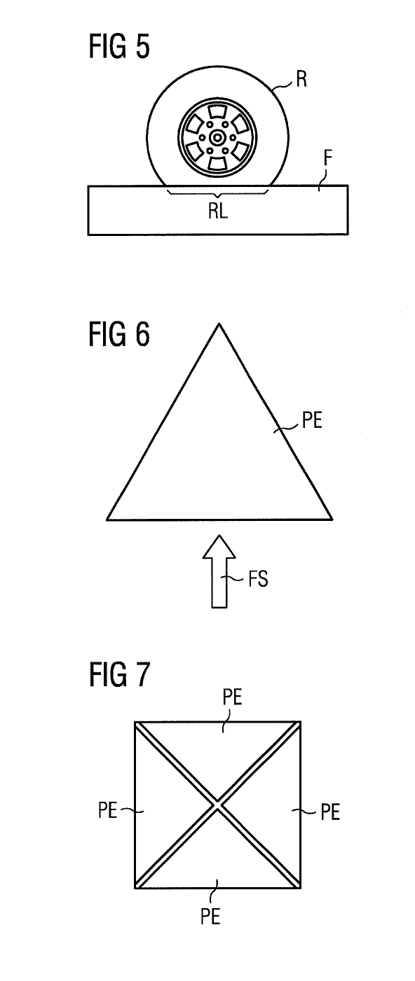

FIG. 5 is a side view of a tire R having a tread-contact area RL as an example of the energy-generation system's deployment. An elastically deformable wall as is present, for example, as a wall of a cavity in a tire's casing is used in the illustration shown in FIG. 5 for changing the volume. The elastically deformable wall is connected to the car tire in such a way that a defined deformation of the tread-contact area will result in a defined deformation of the cavity's wall and hence in a defined deformation of the cavity. A defined pressure surge will develop owing to the defined deformation of the cavity. A solution of such kind is particularly advantageous with regard to the above-described tire sensor system because the energy necessary for operating the tire sensor system can be provided by the tire itself. The deformations described are moreover independent of the vehicle's speed. Only a frequency of pressure-surge formation is dependent on the vehicle's speed.

In the illustration shown in FIG. 5, the cavity is located in a car tire R in such a way that the formation of tread-contact area RL will result in the formation of the pressure surge. Tread-contact area RL forms while the tire is rolling along a roadway F.

FIG. 6 shows an exemplary piezoelectric strip (or, as the case may be, piezoelectric cantilever beam) having a substantially triangular base area. Fluid flow FS impacts substantially perpendicularly on the front side of piezo triangle PE and causes the piezo strip to vibrate. The triangular base area will provide highly efficient energy converting. The piezoelectric strip shown in FIG. 6 can be used, for example, in the energy converter shown in FIG. 4.

FIG. 7 shows an exemplary arrangement of piezoelectric elements PE having in each case a substantially triangular base area for use in a piezoelectric energy converter. The piezoelectric elements (PE) are arranged such as to produce a substantially square overall base area and with the fluid flow impacting substantially perpendicularly on the overall base area. Piezoelectric elements PE are therein linked along their respective side edges to the inside of the energy converter or, as the case may be, to a fluid flow guide belonging to the energy converter. That arrangement will ensure efficient energy converting.

Autonomous energy-generation system, embodied in particular as an integrated miniaturized energy-generation system, based on MEMS technology, including a piezoelectric energy converter for converting mechanical energy into electric energy, having at least one piezoelectric element into which a mechanical force (in particular a deformation force) induced by a fluid flow can be coupled in such a way that the piezoelectric element will be excited to mechanically vibrate, and with an integrated circuit (ASIC) being used for managing the energy provided by the piezoelectric energy converter.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. An energy-generation system, comprising:
a housing having a housing chamber through which a fluid flow is ducted, the housing chamber having a variable volume;
a piezoelectric energy converter to convert mechanical energy into electric energy, the piezoelectric energy converter having a piezoelectric element arranged in the housing chamber such that the fluid flow excites a mechanical vibration in the piezoelectric element and produces electric energy;
means for changing the volume of the housing chamber in response to mechanical deformation energy, the volume change creating fluidic pressure energy and thereby the fluid flow; and
an integrated circuit to manage the electric energy produced by the piezoelectric energy converter.

16. The energy-generation system as claimed in claim 15, wherein the volume change creates a pressure surge or a pressure suction in the housing chamber to thereby induce the fluid flow.

17. The energy-generation system as claimed in claim 15, wherein the means for changing the volume comprises an elastically deformable wall or partial wall of the housing.

18. The energy-generation system as claimed in claim 15, wherein the means for changing the volume comprises deformable mechanical parts of the housing.

19. The energy-generation system as claimed in claim 15, wherein the piezoelectric element has a multilayer structure comprising MEMS layers.

20. The energy-generation system as claimed in claim 15, wherein the piezoelectric element has a piezo strip.

21. The energy-generation system as claimed in claim 20, wherein the piezo strip has a substantially triangular surface area.

22. The energy-generation system as claimed in claim 15, wherein the piezoelectric element comprises a membrane configured such that the fluid flow impacts substantially perpendicularly on the membrane, with the membrane having at least two intersecting membrane slots allowing membrane sections to mechanically vibrate.

23. The energy-generation system as claimed in claim 15, wherein
the piezoelectric energy converter has a plurality of piezoelectric elements each with a substantially triangular surface area, and
the piezoelectric elements are arranged in such a way that a combined element having a substantially square overall surface area is produced, with the fluid flow impacting substantially perpendicularly on the overall surface area.

24. The energy-generation system as claimed in claim 15, wherein a plurality of piezoelectric energy converters are connected in series.

25. The energy-generation system as claimed in claim 15, wherein the integrated circuit uses the electric energy from the piezoelectric energy converter to power an energy-self-sufficient sensor and/or actuator system.

26. The energy-generation system as claimed in claim 16, wherein the means for changing the volume comprises an elastically deformable wall or partial wall of the housing.

27. The energy-generation system as claimed in claim 26, wherein the means for changing the volume comprises deformable mechanical parts of the housing.

28. The energy-generation system as claimed in claim 27, wherein the piezoelectric element has a multilayer structure comprising MEMS layers.

29. The energy-generation system as claimed in claim 28, wherein the piezoelectric element has a piezo strip.

30. The energy-generation system as claimed in claim 29, wherein the piezo strip has a substantially triangular surface area.

31. The energy-generation system as claimed in claim 30, wherein the piezoelectric element comprises a membrane configured such that the fluid flow impacts substantially perpendicularly on the membrane, with the membrane having at least two intersecting membrane slots allowing membrane sections to mechanically vibrate.

32. A remote sensor for a tire, comprising:
a housing chamber through which a fluid flow is ducted, the housing chamber being provided inside the tire and having a volume that changes in response to mechanical deformation energy, to thereby create the fluid flow;
a piezoelectric energy converter to convert mechanical energy into electric energy, the piezoelectric energy converter having a piezoelectric element arranged in the housing chamber such that the fluid flow excites a mechanical vibration in the piezoelectric element and produces electric energy;
a remote sensor provided inside the tire to sense a condition inside the tire; and
an integrated circuit to manage the electric energy produced by the piezoelectric element to match an amount of energy required by the remote sensor with an amount of energy produced by the piezoelectric element.

33. A method for providing energy for an energy-self-sufficient system, comprising:
ducting a fluid through a housing chamber having a volume;
varying the volume of the housing chamber in response to mechanical deformation energy, the change in volume creating a fluidic pressure differential to cause the fluid to flow;
allowing the fluid to flow past a piezoelectric element provided within the housing chamber, such that force on the piezoelectric element from the fluid flow excites the piezoelectric element to mechanically vibrate and convert mechanical energy into electrical energy; and
controlling the system with an integrated circuit so as to match an amount of energy required by a load with an amount of energy produced by the piezoelectric element.

34. The method as claimed in claim 33, wherein
the load is a sensor circuit provided within a tire,
the housing chamber and the piezoelectric element are also provided with the tire, and
fluid flow excites the piezoelectric element to vibrate independent of a rotational speed of the tire.

35. The method as claimed in claim 33, wherein a stationary, time independent fluid flow excites the piezoelectric element.

36. The method as claimed in claim 33, wherein a time dependent fluid flow that changes over time is used to excite the piezoelectric element.
